(19) United States
(12) Patent Application Publication
(10) Pub. No.: US 2007/0178836 A1
(43) Pub. Date: Aug. 2, 2007

(54) Fixed frequency transmitter and disposable receiver system for use in sporting events

(76) Inventor: Larry A. Coulter, Hartselle, AL (US)

Correspondence Address: BUSH INTELLECTUAL PROPERTY LAW GROUP, LLC, P.O. BOX 381146, BIRMINGHAM, AL, 35238, US

(21) Appl. No.: 11/652,404

(22) Filed: Jan. 11, 2007

Related U.S. Application Data
(60) Provisional application No. 60/760,027, filed on Jan. 19, 2006.
(60) Provisional application No. 60/817,596, filed on Jun. 29, 2006.

(51) Int. Cl. H04B 5/00; H04M 1/00

(52) U.S. Cl. 455/41.1; 455/575.2

(57) ABSTRACT

A system for transmitting a fixed frequency radio signal to a hands-free earpiece unit to provide audio information of an event to a user. A transmitter receives an airwave broadcast signal and conditions the airwave broadcast signal into a single frequency signal. The transmitter transmits the single conditioned frequency signal to a receiver in the earpiece unit. The receiver, in conjunction with a power supply, amplifies the conditioned single frequency signal for audio output through an audio speaker in the earpiece unit. The earpiece unit is disposable in that the receiver spontaneously fails to receive the conditioned single frequency signal so that the earpiece unit fails to function within 24 hours of use. The receiver has a total current consumption of 10-15 mA. The receiver receives a low frequency signal so that it operates in a system that does not require Federal licensing, or a standard commercial broadcast free airwave signal that requires FCC registration based only on successful emissivity testing results. The earpiece unit has an earpiece with a receiving antenna, with the earpiece fitting on or in a user's ear. The receiver, the audio speaker, and the power supply are encased on a circuit board forming a hands free unit in combination with the earpiece.

### REFERENCE TO RELATED PATENT APPLICATIONS

The present application claims priority to U.S. Provisional Patent Application No. 60/760027, filed Jan. 19, 2006, and U.S. Provisional Patent Application No. 60/817596, filed Jun. 29, 2006, the disclosures of which are incorporated herein by reference.

### FIELD OF THE INVENTION

The present invention relates to transmitter and receiving systems and, more particularly, to a system and method for short range and short term radio transmission of sporting and entertainment events to a disposable radio receiver hearing earpiece which self-terminates after use.

### BACKGROUND OF THE INVENTION

There have been numerous technological innovations that have enhanced a spectator's experience at sporting events and other types of entertainment events, including devices such as big video screens with instant replays. There are also live broadcasts on radio and television, but access to live commentaries generally requires spectators to bring their own radios or televisions which can be inconvenient or impractical, particularly because these devices are not hands-free. Consequently, in most cases spectators cannot clearly hear commentaries about everything that is occurring during an event. Hands-free earpieces are known for hearing-aid circuitry or telephonic circuitry, but there are no practical disposable non-reusable hands-free earpieces designed exclusively for receiving radio or television broadcast signals. In addition, post 9-11 Homeland Security implications will drive many venues to disallowing the use of portable electronic devices from being brought into facilities, from the outside, for security reasons.

What is needed is a method and system for transmitting and receiving live event commentary under controlled conditions which provide audio output through a self-contained disposable and self-terminating receiver hearing earpiece and which comply with Federal regulations.

### SUMMARY OF THE INVENTION

The present invention is a method and system for providing audio output of radio or television broadcast signals to a self-contained disposable hands-free receiver hearing earpiece. A transmitter receives a free airwave broadcast signal and conditions the free airwave broadcast signal to a single frequency. The transmitter then transmits the conditioned single frequency signal to a nontunable receiver contained in the earpiece. The receiver receives the low frequency signal and conditions the signal for amplification for audio output through a speaker in the earpiece. The earpiece unit fits into or onto the outer ear and is light weight, preferably less than 0.5 to 2 ounces, with a moldable (pliable) ergonomic design element that mates to the user's ear. It is self contained with a built-in receiving antenna, and is self terminating in that the receiver fails to function within 24 hours. The device can be hypoallergenic and disposable, having a non-adjustable audio output less than 100 db wherein volume can be controlled by the transmitter, or be used to simply receive a free airwave broadcast signal.

An advantage of the broadcast method and system of the present invention is radio reception of information about sporting events and the like in a hands-free receiver hearing earpiece worn on or in the ear.

Another advantage is the reception and transmission of free airwave broadcast signals to the receiver earpiece.

Another advantage is a nontunable, hypoallergenic, self-contained disposable earpiece with the radio receiver, speaker, power source, and associated electrical circuitry housed within the earpiece.

Another advantage is a self-terminating design in the earpiece so that it ceases to function spontaneously within 24 hours of use.

Another advantage is that the system can be constructed to operate without requiring FCC federal licensing.

### BRIEF DESCRIPTION OF THE DRAWINGS

FIG. 1 shows the method of radio transmission of sports events to a radio receiver hearing earpiece of the present invention.

FIG. 2 shows an illustration of a typical installation of the transmitter and radio receiver hearing earpiece of the present invention in a sports arena.

FIG. 3 shows a diagram of the basic circuitry of the transmitter of present invention.

FIG. 4 shows a diagram of the basic circuitry of the receiver of the present invention.

FIG. 5 shows an illustration of a radio receiver hearing earpiece of the present invention.

### DETAILED DESCRIPTION OF THE PREFERRED EMBODIMENTS

While the following description details the preferred embodiments of the present invention, it is to be understood that the invention is not limited in its application to the details of construction and arrangement of the parts illustrated in the accompanying drawings, since the invention is capable of other embodiments and of being practiced in various ways.

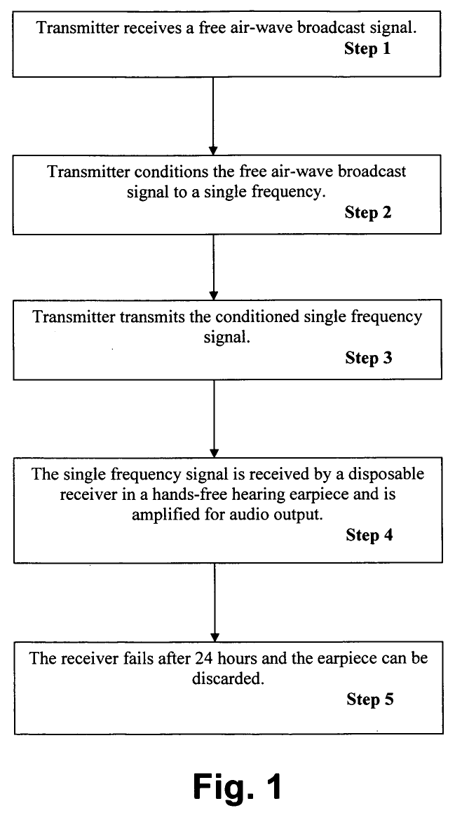

FIG. 1 shows the method of the present invention. A transmitter receives a free airwave broadcast signal (step 1). The free airwave broadcast signal is conditioned to a single frequency (step 2). The transmitter then transmits the conditioned single frequency signal to a receiver hearing earpiece (step 3). The single frequency signal is received by the receiver hearing earpiece and amplified for audio output through a speaker in the earpiece (step 4). The receiver then fails to function after a specified amount of time, for example, 1 to 24 hours (step 5).

The hearing-aid styled receiver earpiece fits into or onto the ear, preferably the outer ear. The earpiece unit should weigh 0.5 to 2 ounces, have a moldable or pliable cover design, and be self-contained with the radio receiver, speaker, power source, and associated electrical circuitry housed within the earpiece. The receiver earpiece can be powered by one or more solar or light cells or by one or more batteries, or by a combination thereof. The receiver earpiece also can have a non-adjustable audio output and a built-in receiving antenna. It can also have other features including a hypoallergenic composition and a one time use design rendering the receiver earpiece disposable. The system of the present invention may comprise a single component of the described components or a mixed quantity of the described components, as required by the venue or desired physical and radio frequency (RF) characteristics.

The system and method of the present invention is designed for hearing the play-by-play commentary at sporting events or other venues as needed, and can be differentiated from standard or other existing designs in the following ways. The transmitter and receiver can have a fixed frequency, i.e. be non-tunable. The receiver may also have no volume control or adjustment. The receiver can be disposable, and may also be non-reusable by having a life span preferably less than 24 hours by design. The receiver may be used independently of the transmitting unit by receiving a standard commercial broadcast transmission frequency, and may receive any type of frequency such as AM, FM, microwave, UHF or VHF. The system can be constructed to operate without requiring FCC licensing by operating at a lower power, shorter range, and lower frequency than required for FCC licensing. The system can also be constructed to operate on a standard commercial broadcast free airwave signal that requires FCC registration based only on successful emissivity testing results. The entire radio receiver can be contained within the hearing earpiece.

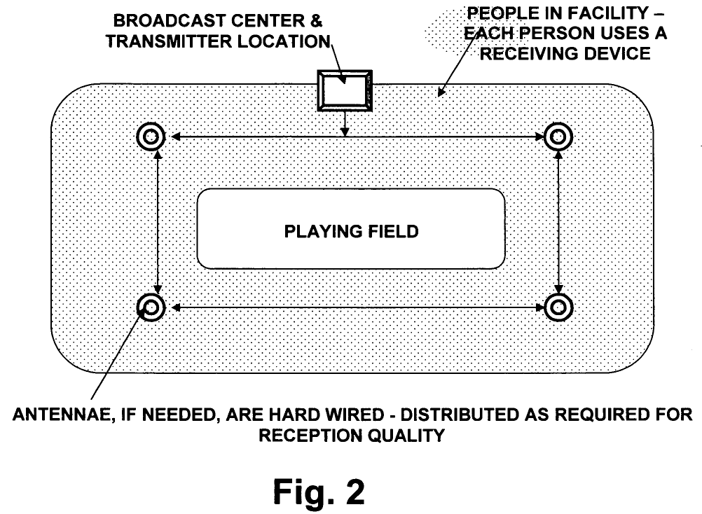

FIG. 2 shows a typical installation of the present invention for an arena-type facility. A mobile transmission facility may also be used in the arena-type facility or in a more open setting such as open fields.

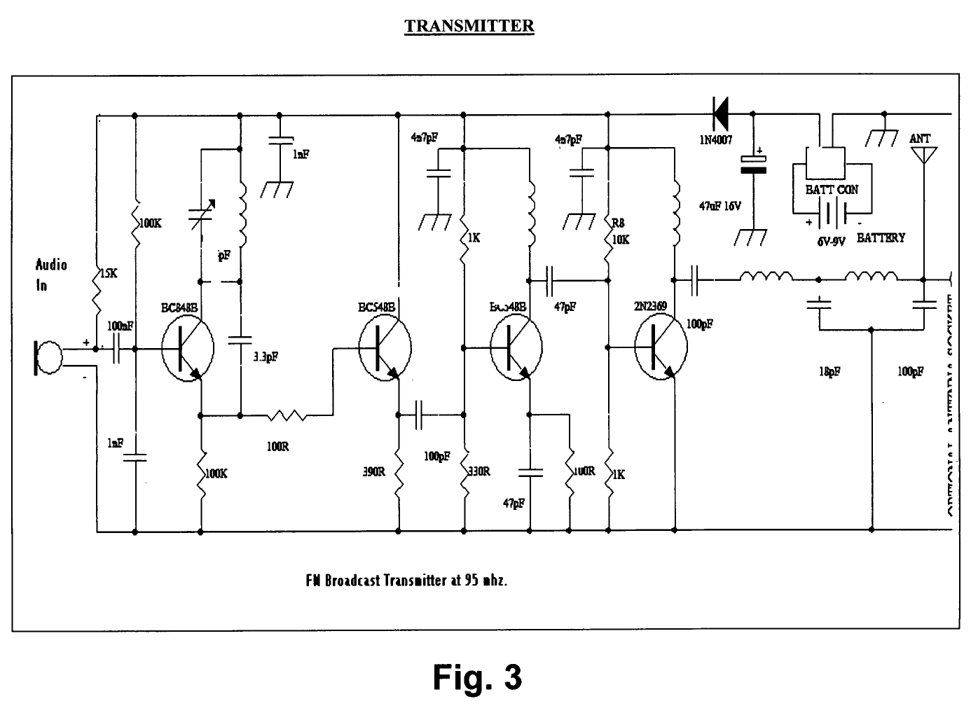

The transmitter is, preferably, a low frequency unit which picks up a free airwave broadcast signal, conditions it to a minimally low frequency not used in common transmitting employed by television, radio or microwave (or other commercially used signal frequency), and transmits the conditioned signal via an antenna to a receiving unit. FIG. 3 shows a diagram of the basic circuitry of the transmitter of the present invention. Audio input and RF output are provided by RCA jack connectors. The unit is powered with an 110 v ac source, converted to a 12 v dc supply at 500 milliamps. The output signal is adjustable. The output signal is at an estimated fixed MHz with a limited range in free space, preferably a radius of about one mile. The unit is equipped with LEDs to indicate power ready and signal transmission. Transmission antennae, if required, can be double die-pole omni directional antennae.

The receiver receives the low frequency signal and conditions the signal for amplification. A hearing-aid styled hearing earpiece containing the receiver fits into or onto the outer ear. The unit is light weight, preferably 0.5 to 2 ounces, with a moldable (pliable) ergonomic design, and is self contained and self terminating. The device can be nontunable, hypoallergenic and disposable, having a non-adjustable audio output less than 100 db, preferably about 85 to 92 db and a built-in receiving antenna. Volume can be controlled by the transmitter.

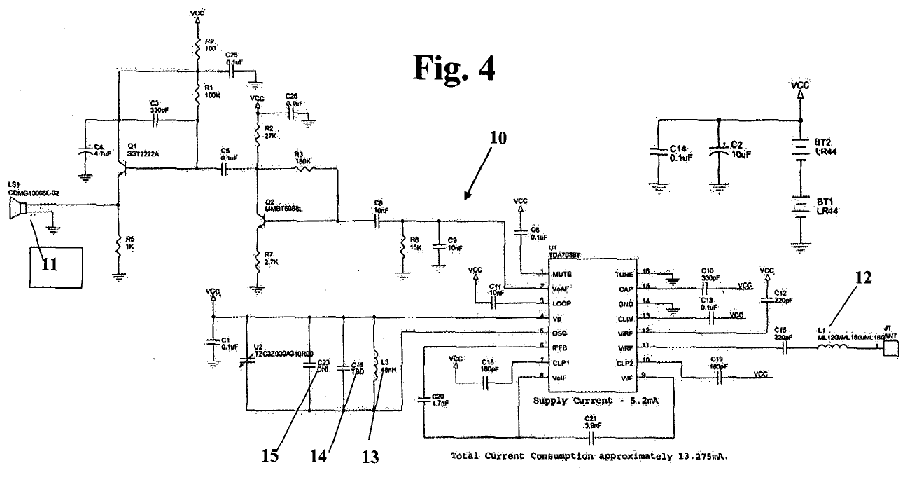

The receiver can be of any suitable type known in the art, including a discrete super regenerative receiver or an IC-based synthesized super heterodone receiver. FIG. 4 shows a diagram of the basic circuitry of a preferred receiver 10 of the present invention. The antenna is standard loop. The circuit directly drives a small speaker 11 using batteries. All electronics can be encapsulated into a single integrated circuit. The output audio can operate at a safe and tested decibel level. Receiving frequency can be determined on a case-by-case basis but the receiver is designed to receive one channel, preferably on a FM broadcast band with the ability to capture television broadcast signals. This unit can be designed to fail within any time limit desired, preferably within 24 hours, and then discarded. A preferred way to produce self termination of the use of the receiver is to use a battery system that fails within 6 to 10 hours, The receiver 10 shown in FIG. 4 has a total current consumption of approximately 10-15 mA, preferably about 13.275 mA. By powering the unit with two 3.5 amp 1.5 volt silver oxide batteries (LR44 Duracell™) the unit will function from about 6 to 10 hours, expending all the power in the batteries and then failing. L1 12 will vary with the frequency range. A 1.5 nH works well for 93.7 MHz. L1 12 can be adjusted for different frequencies. L3 13 is a 48 nH, HQ 2% inductor (CoilCraft). C16 14 can vary depending on the frequency. C16 14 should start at a 33 pF for frequencies at the high end of the broadcast band (107-108 MHz). For frequencies more towards the bottom end of the broadcast band (88-93 MHz) C 16 14 should start a 47 pF. C23 15 is used to adjust the frequency accordingly. A 0.5 pF increases the frequency approximately 0.58 MHz and a 1 pF increases the frequency approximately 1 MHz.

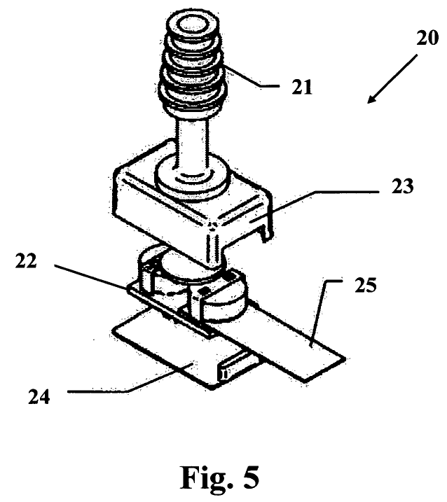

FIG. 5 shows an illustration of a radio receiver hearing earpiece unit 20 of the present invention. The device 20 has an earpiece 21 which can be inserted into the outer ear. The earpiece 21 has a built in receiving loop antenna (not shown). Circuit board 22 contains a receiver 10 and a speaker 11 which are encased in a cover formed by a top cover 23 and a bottom cover 24 forming a single hands free unit 20 with the earpiece 21. The power supply (not shown) can be encased in the cover and/or mounted on the circuit board 22. A pull tab 25 is used to activate the receiver 10 by pulling tab 25 out of the circuit board 22.

The foregoing description has been limited to specific embodiments of this invention. It will be apparent, however, that variations and modifications may be made by those skilled in the art to the disclosed embodiments of the invention, with the attainment of some of all of its advantages and without departing from the spirit and scope of the present invention. For example, the receiver may be used independent of the transmitter. Various means known in the art may be used to cause the receiver to fail spontaneously, such as, for example, a fused link within the circuitry. Any suitable earpiece shape may be used. Audio output can be in stereo. Other mechanisms may be used to activate the earpiece such as push-in type pins, a push-button type switch, or a magnetically operated sealed on-off switch.

It will be understood that various changes in the details, materials, and arrangements of the parts which have been described and illustrated above in order to explain the nature of this invention may be made by those skilled in the art without departing from the principle and scope of the invention as recited in the following claims.

1. A method for transmitting a fixed frequency radio signal to an earpiece unit to provide audio information of an event to a user, comprising the steps of:
1) receiving an airwave broadcast signal by a transmitter;
2) conditioning the airwave broadcast signal to a single frequency signal by said transmitter;
3) transmitting the conditioned single frequency signal by said transmitter;
4) receiving said conditioned single frequency signal by a receiver in said earpiece unit; and
5) amplifying said conditioned single frequency signal by said receiver for audio output through a speaker in said earpiece unit.

2. The method of claim 1 wherein the step of conditioning comprises conditioning the airwave broadcast signal to a low frequency signal that is not used in transmitting by commercial television, radio, or microwave.

3. The method of claim 1 wherein the step of transmitting comprises transmitting a fixed MHz signal over a range having a radius of about 1 mile or less.

4. The method of claim 1 wherein the step of receiving said conditioned single frequency signal terminates spontaneously so that said earpiece unit fails to function within 24 hours of use.

5. A method for transmitting a fixed frequency radio signal to an earpiece unit to provide audio information of an event to a user, comprising the steps of:
1) receiving an airwave broadcast signal by a transmitter;
2) conditioning the airwave broadcast signal to a single low frequency MHz signal that is not used in transmitting by commercial television, radio, or microwave;
3) transmitting said conditioned single low frequency MHz fixed signal by said transmitter over a range having a radius of about 1 mile or less;
4) receiving said conditioned single low frequency fixed MHz signal by a receiver in said earpiece unit; and
5) amplifying said conditioned single low frequency fixed MHz signal by said receiver for audio output through a speaker in said earpiece unit.

6. The method of claim 5 wherein the step of receiving said conditioned single low frequency fixed MHz signal terminates spontaneously within 24 hours of use so that said earpiece unit fails to function.

7. A method for transmitting a fixed frequency radio signal to an earpiece unit to provide audio information of an event to a user, comprising the steps of:
1) receiving an airwave broadcast signal by a transmitter;
2) conditioning the airwave broadcast signal to a single low frequency MHz signal that is not used in transmitting by commercial television, radio, or microwave;
3) transmitting said conditioned single low frequency MHz signal by said transmitter over a range having a radius of about 1 mile or less;
4) receiving said conditioned single low frequency MHz signal by a receiver in said earpiece unit, wherein receiving said conditioned single low frequency MHz signal by said receiver terminates spontaneously within 24 hours of use so that said earpiece unit fails to function; and
5) amplifying said conditioned single low frequency MHz signal by said receiver for audio output through a speaker in said earpiece unit.

8. A system for transmitting a fixed frequency radio signal to an earpiece unit to provide audio information of an event to a user, comprising:
a) a transmitter for receiving an airwave broadcast signal;
b) said transmitter conditioning the airwave broadcast signal into a single frequency signal;
c) said transmitter transmitting said single conditioned frequency signal;
d) a receiver in said earpiece unit receiving said conditioned single frequency signal; and
e) said receiver amplifying said conditioned single frequency signal for audio output through a speaker in said earpiece unit.

9. The system of claim 8 wherein said transmitter conditions the airwave broadcast signal to a low frequency signal that is not used in transmitting by commercial television, radio, or microwave.

10. The system of claim 8 wherein said transmitter transmits a fixed MHz signal over a range having a radius of about 1 mile or less.

11. The system of claim 8 wherein said receiver spontaneously fails to receive said conditioned single frequency signal so that said earpiece unit fails to function within 24 hours of use.

12. A system for transmitting a fixed frequency radio signal to an earpiece unit to provide audio information of an event to a user, comprising:
a) a transmitter for receiving an airwave broadcast signal;
b) said transmitter conditioning the airwave broadcast signal into a single low frequency fixed MHz signal that is not used in transmitting by commercial television, radio, or microwave;
c) said transmitter transmitting said conditioned single low frequency fixed MHz signal over a range having a radius of about 1 mile or less;
d) a receiver in said earpiece unit receiving said conditioned single low frequency fixed MHz signal; and
e) said receiver amplifying said conditioned single low frequency fixed MHz signal for audio output through a speaker in said earpiece unit.

13. The system of claim 12 wherein said receiver spontaneously fails to receive said conditioned single low frequency fixed MHz signal so that said earpiece fails to function within 24 hours of use.

14. A system for transmitting a fixed frequency radio signal to an earpiece unit to provide audio information of an event to a user, comprising:
a) a transmitter for receiving an airwave broadcast signal;
b) said transmitter conditioning the airwave broadcast signal into a single low frequency fixed MHz signal that is not used in transmitting by commercial television, radio, or microwave;
c) said transmitter transmitting said conditioned single low frequency fixed MHz signal over a range having a radius of about 1 mile or less;
d) a receiver in said earpiece unit receiving said conditioned single low frequency fixed MHz signal, wherein said receiver spontaneously fails to receive said conditioned single low frequency fixed MHz signal so that said earpiece unit fails to function within 24 hours of use; and
e) said receiver amplifying said conditioned single low frequency fixed MHz signal for audio output through a speaker in said earpiece unit.

15. A radio receiver hearing earpiece unit, comprising:
a) a nontunable radio receiver;
b) an audio speaker;
c) a power supply;
d) an earpiece with a receiving antenna wherein said earpiece fits on or in a user's outer ear; and
e) said receiver, said audio speaker, and said power supply being encased within a cover forming a hands free unit in combination with said earpiece.

16. The radio receiver hearing earpiece unit of claim 15, further comprising a pull-tab to activate said radio receiver hearing earpiece unit.

17. The radio receiver hearing earpiece unit of claim 15 wherein the total current consumption of said receiver is 10-15 mA.

18. The radio receiver hearing earpiece unit of claim 15 wherein said radio receiver self-terminates and ceases to function within 24 hours.

19. The radio receiver hearing earpiece unit of claim 15 wherein said radio receiver receives only a low frequency signal so that said receiver operates in a system that does not require Federal licensing.

20. The radio receiver hearing earpiece unit of claim 15 wherein said radio receiver receives only a single standard commercial broadcast free airwave signal that requires FCC registration based only on successful emissivity testing results.

21. The radio receiver hearing earpiece unit of claim 15 wherein said speaker has a nonadjustable audio output in which the volume of said speaker is controlled by a transmitter.

22. A radio receiver hearing earpiece unit, comprising:
a) a nontunable radio receiver wherein the total current consumption of said receiver is 10-15 mA, and said radio receiver receives only a low frequency signal so that said receiver operates in a system that does not require Federal licensing;
b) an audio speaker;
c) a power supply;
d) an earpiece with a receiving antenna wherein said earpiece fits on or in a user's outer ear; and
e) said receiver and said audio speaker being fixed to a circuit board, and said power supply being encased in a cover and/or on said circuit board wherein said receiver, said audio speaker, said circuit board, said cover, and said earpiece form a hands free unit.

23. The radio receiver hearing earpiece unit of claim 22, further comprising a pull-tab on said circuit board to activate said radio receiver hearing earpiece unit.

24. The radio receiver hearing earpiece unit of claim 22 wherein said radio receiver hearing earpiece unit self-terminates and ceases to function within 24 hours of use.

25. The radio receiver hearing earpiece unit of claim 22 wherein said speaker has a nonadjustable audio output in which the volume of said speaker is controlled by a transmitter.

26. A radio receiver hearing earpiece unit, comprising:
a) a nontunable radio receiver wherein the total current consumption of said receiver is 10-15 mA, said radio receiver receives only a low frequency signal so that said receiver operates in a system that does not require Federal licensing, and said radio receiver self-terminates and ceases to function within 24 hours;
b) an audio speaker wherein said speaker has a nonadjustable audio output in which the volume of said speaker is controlled by a transmitter;
c) a power supply;
d) an earpiece with a receiving antenna wherein said earpiece fits on or in a user's outer ear;
e) said receiver and said audio speaker being fixed to a circuit board, and said power supply being encased in a cover and/or on said circuit board, wherein said receiver, said audio speaker, said circuit board, said cover, and said earpiece form a hands free unit; and
f) a pull-tab on said circuit board to activate said radio receiver hearing earpiece unit.

27. A method for receiving a free airwave radio signal to an earpiece unit to provide audio information of an event to a user, comprising the steps of:
1) receiving a single free airwave signal by a non-tunable receiver in said earpiece unit;
2) amplifying said single free airwave signal by said receiver for nonadjustable audio output through a speaker in said earpiece unit; and
3) terminating said receiving of said single free airwave signal spontaneously within 24 hours of use so that said earpiece unit fails to function.

28. A system for receiving a free airwave radio signal to an earpiece unit to provide audio information of an event to a user, comprising:
a) a non-tunable receiver in said earpiece unit receiving a single free airwave radio signal;
b) said receiver amplifying said single free airwave radio signal for nonadjustable audio output through a speaker in said earpiece unit; and
c) said receiver spontaneously failing to receive said single free airwave radio signal so that said earpiece unit fails to function within 24 hours of use.
